(19) United States
(12) Patent Application Publication
(10) Pub. No.: US 2003/0140554 A1
(43) Pub. Date: Jul. 31, 2003

(54) Shield for protecting plants

(76) Inventor: Carl E. Whitcomb, Stillwater, OK (US)

Correspondence Address: STREETS & STEELE, Suite 355, 13831 Northwest Freeway, Houston, TX, 77040, US

(21) Appl. No.: 10/062,287

(22) Filed: Jan. 31, 2002

(51) Int. Cl. A01G 13/02

(52) U.S. Cl. 47/32.4

(57) ABSTRACT

A shield for use in protecting plants from environmental hazard, most particularly herbicide sprays. The shield is a two-layered structure, comprising an inner layer of a non-abrasive or resilient material secured to an outer layer of a herbicide-impermeable material. The two-layered structure is preferably a flexible composite sheet having two ends coupled together to form a circumferential barrier around the plant stem. The two ends may be coupled together with various fasteners. When a black or dark-colored inner layer is bonded to a white or light colored reflective outer layer, the temperature of the plant inside the shield may be minimized.

### BACKGROUND OF THE INVENTION

1. Field of the Invention

This invention relates generally to a shield for protecting a plant, more particularly for protecting the stem of a woody plant, such as a tree or a shrub.

2. Background of the Related Art

The stems or trunks of woody plants, such as shrubs and trees, often need to be protected from various forms of insult, such as chemical or mechanical. Other plants, especially when young, are also vulnerable to damage by wind and herbicides. Numerous devices exist to protect trees and stems from various threats in their environment. Protection of tree trunks from mechanical damage is taught by Campbell, U.S. Pat. No. 5,048,229. Allen, U.S. Pat. No. 5,231,793, teaches a ground covering and tree ring for the protection of tree bark from mechanical injury by lawn equipment and growth inhibition of undesired vegetation. Pattyn, U.S. Pat. No. 5,878,528, discloses the use of a rigid plastic shield for use as a tree protector. This device is applied in urban settings where snow, slush and salt applied to roads can damage trees in winter. Taylor, U.S. Pat. No. 4,845,889, teaches a shield for protecting plants from weed and lawn trimming devices. Worzek, U.S. Pat. No. 4,648,203, discloses a permanently installable plant or tree protection device to guard against mechanical insult, such as that inflicted by lawnmowers and string trimmers. Allen, U.S. Pat. No. 4,700,507, teaches the use of a high impact polyurethane plastic shield to protect tree bark. Graves, U.S. Pat. No. 4,922,052, teaches a flexible tree “shelter” to protect a tree or other plant from the growth of encroaching weeds and weather effects. Scharf, U.S. Pat. No. 4,268,992 discloses a tree protector in the form of a vertical hollow shaft, with a built-in watering device. This protector is for use with young trees and shrubs, to guard against small animals and damage from lawnmowers.

Weed control around nursery stock (young plants and other plants) grown in the field is a major problem. Weeds compete for water and nutrients with these plants and, if left unchecked, the weeds can often grow taller than the young plants, thereby restricting light access and causing stunting and even plant death. To control weeds among young plants without disturbing the soil and without getting contact herbicides on the stem of the plant is highly desirable. The stems of young plants and trees contain chlorophyll and are subject to damage from contact with such post-emergent herbicides as Roundup® (Monsanto, St. Louis, Mo.), Gramoxone® (Imperial Chemical Industries, London, England), Dilic, or Scythe® (Mycogen, San Diego, Calif.). While these products are effective and economical for controlling weeds, they may also damage or kill the stems of young plants. For example, when a paraquat spray, such as Gramoxone® (Imperial Chemical Industries, London, England), is sprayed down each side of tree rows in the field, stem growth is restricted on the sides exposed to the greatest quantity of herbicides. Growth of the affected stems is then elliptical and weakened, in contrast to a normal round or near-round stem configuration. When a glyphosate, such as Roundup® (Monsanto, St. Louis, Mo.), is applied, damage to nursery crop plants is primarily due to stem absorption, which stunts plant growth.

The use of products that are either dark-colored or translucent or clear or nearly so results in substantial heating around the stem of the plant. This heating results in additional height growth accompanied by reduced stem diameter and strength, often requiring young trees to be staked, an expensive and laborious process. Also, excessive heating around the stems of young trees and shrubs can produce growth distortion and cause excessive growth of adventitious shoots and suckers. Abnormal heating around the stems of young trees also encourages insect and mite infestation. Concomitant enlargement of cells due to the effects of heat also results in thinner cell walls and an increased likelihood of pathogen entry. These problems occur when using the devices taught by Pattyn, U.S. Pat. No. 5,878,528, which suggests the use of a green-colored shield, or the use of the device taught by Allen, U.S. Pat. No. 5,231,793, which recommends the use of a black colored ground covering.

Additionally, most devices sold as stem protectors are rigidly formed and, when the wind blows, the plant stem, the protector, or both move sufficiently as to cause abrasion damage to the plant stem at the top of the device. This is seen in the devices taught by Campbell, U.S. Pat. No. 5,048,229; Taylor, U.S. Pat. No. 4, 845,889; Allen, U.S. Pat. No. 4,700,507; and Scharf, U.S. Pat. No. 4, 268,992.

Therefore, a need exists for a chemical shield for preventing post emergent herbicides being sprayed in the vicinity of young plants from contacting the stems of those plants in order to maximally exploit the economic and environmental benefits of such herbicides. It would be desirable if the plant shield prevented overheating and deleterious thermal effects and did not cause physical damage to the plant.

### SUMMARY OF THE INVENTION

The present invention provides a shield for protecting a plant, for example, a woody plant, such as a shrub or tree. The shield comprises a flexible composite sheet having a first layer of non-abrasive, porous material that is secured to a second layer of a water or chemical impermeable material. Although the second layer may be water or chemical impermeable, it must be herbicide impermeable. In a preferred embodiment, two layers form the shield, but any number of layers may be used. Two ends of the flexible composite sheet may be wrapped around the plant stem or trunk and coupled to form the shield with the first layer facing the plant stem or trunck. Ideally, the flexible composite sheet is sufficiently stiff that the shield formed around the plant is more or less self-supporting, but not so rigid as to damage the plant. The flexible composite sheet may also form a generally circumferential barrier, such as a generally cylindrical ring, by securing together two ends of the flexible composite sheet. The two ends may be secured together by a fastener selected from staples, adhesives, snaps, clasps, hook and loop fasteners, and combinations thereof.

### BRIEF DESCRIPTION OF THE DRAWINGS

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a young tree in the ground, with the plant shield of the instant invention encircling the trunk.

FIG. 2 is a cross-sectional side view of the plant shield, depicting its bilayer construction.

FIG. 3 is a graph of temperature differences using various chemical shields.

### DETAILED DESCRIPTION OF THE INVENTION

The present invention provides a shield for protecting young plants, more particularly, woody plants such as trees and shrubs. The shield comprises a two-layered structure that protects the plant from damage by herbicides and other chemicals, as well as creates a healthful environment for the plant by safeguarding it from excessive heat, moisture and physical damage. The two-layered structure comprises an inner layer bonded or otherwise coupled or secured to an outer layer.

The primary requirement for the material of the inner layer is that the material be resilient and non-abrasive, to avoid any stem damage or chafing. This material may be any fabric that, when coupled to a layer of a herbicide-impermeable material on one side surface (i.e. face-to-face), will provide the resulting two-layered structure with the capacity to deflect light and not subject the shielded plant to overheating. Preferably the fabric is thick enough so that the fibers can hook on to or attach to any rough surface of bark. The material of the inner layer need not be porous, although it can be.

While the fabric of the inner layer may be made from various materials, the fabric is preferably a polymer such as polypropylene, polyester, nylon, or other olefin. Preferably, a spun bonded needle punched fabric may be used. Preferably, the fabric has a weight ranging from 1 to 10 ounces per square yard, and more preferably ranging from 4 to 6 ounces per square yard. To shield the plant stem from the effects of light and UV radiation, the inner layer is preferably a dark color, most preferably black. Using a dark color ensures that light does not penetrate the inner layer, but rather any light penetrating the outer layer is absorbed by the inner layer before the light reaches the stem to cause direct radiant heating of the plant stem.

The outer layer is a herbicide-impermeable material, which may also be water-impermeable or chemical-impermeable. This material may be any material that does not permit herbicides, or other chemicals or water respectively, to penetrate the material and make contact with the plant stem, including such materials as films, dense fabrics, aluminum or other metal foil, and plastic sheets. The herbicide-impermeable layer may also be formed by any material or composition, including polymers, inorganics, and composites, with polymers being the most preferred. Polymers such as vinyl, or polyolefins such as polyethylene, polypropylene, polyisobutene, poly but-1-ene, and poly 4-methyl-pent-1-ene may be used. Preferably, the herbicide-impermeable material is reflective and light colored or has a reflective and light colored coating or surface. The most recommended material is white polyethylene, which is suitable to reflect light and reduce the temperature in the cylinder around the plant. The white outside color reflects light and reduces the temperature inside the shield, which avoids problems with adventitious bud growth, insects, and mites, as might occur with translucent plant stem protectors.

The composition of the herbicide-impermeable material may also comprise additives. For example, where the herbicide-impermeable material is a polymer, the polymer will preferably include UV inhibitors to provide high UW stability. In a most preferred embodiment, the herbicide-impermeable material forming the outer layer of a two-layered plant shield comprises white polyethylene having a thickness of between 2 and 6 mils and with UV inhibitors for stability. Additionally, the herbicide-impermeable material may be rigid or flexible and have any desired thickness, preferably between 2 and 6 mils, more preferably between 3 and 5 mils. Further, the herbicide-impermeable material is preferably resistant to decay. Such materials resistant to decay include, without limitation, polymers such as vinyl or polyolefins.

As mentioned, the herbicide-impermeable material and non-abrasive material may be attached, coupled, or secured together by various means, including lamination, use of an adhesive, stitching, stapling, hook and loop fasteners, snaps and the like. For example, a white polyethylene material may be adhered to an inner fabric material, such as a spun bonded and needle punched fabric or a woven or knitted fabric. Any adhesive may be used, but preferably the adhesive is water-insoluble. Furthermore, any lamination techniques may be used, provided that the lamination temperature employed does not melt the non-abrasive material, or completely dissolve the herbicide-impermeable materials. Alternatively, one of the materials may be formed directly onto the other material, such as the herbicide-impermeable material being sprayed over the non-abrasive material. The materials forming the two layers may also be secured together at spaced apart intervals, for example, every inch or two.

Another embodiment of the invention includes the use of composite material, comprising one or more of the non-abrasive layers and one or more herbicide-impermeable layers, to form a protective shield, wherein a herbicide spray is prevented from contacting the stem of a plant. The protective shield may have any shape or size, provided that the non-abrasive layer faces the stem. In a preferred embodiment of the invention, the shield is generally cylindrical in shape, formed from a rectangular sheet of the composite material. Such shields should be made to fit around the stems of young plants such as trees and extend sufficiently high to prevent herbicide sprays from contacting the sensitive tissue of the stem.

The shields are preferably assembled in the field by stapling or otherwise coupling a flat sheet of the composite material along two opposing edges. Alternatively, the two-layered shield may be assembled by wrapping the material around a plant stem and securing it by taping across the overlapping surfaces or by tying a string or flexible band around the shield. The two opposing edges may also be coupled with hook and loop fasteners, or an adhesive with a protective covering that is removed just prior to use. In a preferred embodiment of the invention, the shield is assembled from pieces of the composite material that measure 15 inches wide by 24 inches tall. The shield is installed around the stem of a young plant using a heavy-duty hand stapler. Such a composite material shield is sufficiently rigid to form a freestanding shield around the stem. A shield of this size protects the young plant stem from chemicals 24 inches above the soil surface and allows the plant to grow to a stem diameter of about 3.5 inches. Suitably, when the stem diameter of a tree reaches about 3 inches, the mature bark is sufficiently developed to prevent chemical absorption and damage from post-emergent herbicides. At this stage the shield may be removed and either discarded or reused around other plant stems. Therefore, the shield provides temporary protection of a plant during an early, crucial phase of development. If the shield is not removed by the time the plant reaches the inside diameter of the shield, the pressure of the expanding stem will cause the staples to release with no damage to the plant.

The composite material may be used to make protective shields of various sizes for use in protecting various types and sizes of plants. The size or volume of the shield may be enlarged for use in protecting larger plants, or plants at a later state of development.

The present invention further provides methods of using the plant shield in horticulture and recreational gardening. Rolls of the bilayer material may be produced and kept available so that the material may be cut and formed into shields having shapes and sizes desirable for a variety of applications as the need arises. Particularly, the material may be formed into a ring that can protect trees and other plants when coupled to form tree protectors.

It is preferred, for purposes of economy and efficiency, that the composite material used in forming the protective shield is also suitable as a root-growth barrier as that term is described in Applicant's copending U.S. nonprovisional patent application, Express Mail Number EL833794866US, filed on Oct. 29, 2001, which application is incorporated by reference herein.

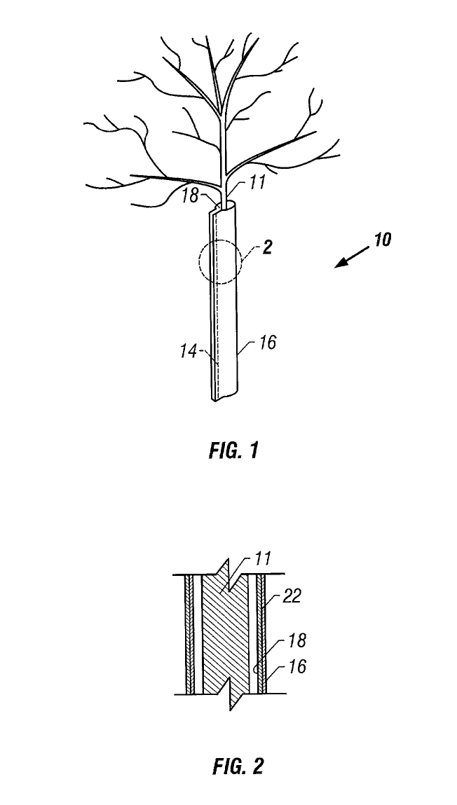

FIG. 1 is a perspective view of a protective shield 10 of the invention disposed around a plant stem 11. The shield 10 is shown having a vertical seam 14 where two opposing edges of a composite material are joined. Such a seam may be formed by stapling, or any other method of fastening the material in place around the stem. The herbicide-impermeable material 16 is preferably white polyethylene to provide reflectivity. The non-abrasive material 18 is preferably a dark colored spun bonded fabric that becomes hooked onto the rough edges of the bark to prevent excessive movement of the shield that could cause abrasion.

FIG. 2 is a cross-sectional side view of the shield 10 in FIG. 1, showing the composite material in greater detail. The herbicide-impermeable material 16 is coupled to the non-abrasive material 18. In a preferred embodiment of the invention, the bonding interface or region 22 between the layers is formed by laminating the herbicide-impermeable material 16, such as a polyethylene film, onto a fabric non-abrasive material 18.

### EXAMPLE 1

A two-layered material was prepared by laminating a 4 mil thick sheet of white polyethylene to a 6 ounce per square yard sheet of spun bonded needle punched black polypropylene. The material was cut to dimensions of 24 inches tall by 15 inches wide, wrapped around the stem of a young tree, and fastened up the vertical seam using a hand stapler to form a shield. The wire staples held the shield in place. Lacebark elm trees of similar size and condition were given shields, with a first group of the trees receiving clear or opaque, corrugated, double wall tree shelters and a second group receiving the foregoing two-layered shield, white on the outside. A third group of trees received no shields, and served as a control group. The tree stems with clear or opaque stem coverings had a high incidence of coral spot Nectria canker, Nectria cinnabarina (47%) (Group I), whereas stems protected by the two-layered shield (Group II) had no canker and stems that were unprotected by any covering (Group III) also had no canker. Following removal of the clear or opaque coverings, the stem wounds caused by the canker in the trees in Group I began to be covered by callous growth and some were completely covered over within three months. Although this growth resulted in the canker wounds being covered in some cases, the appearance of the tree stem was such that the trees would not be of salable quality. Furthermore, the trees of Group I displayed the emergence of numerous adventitious buds. None of the trees in Groups II or III displayed such undesirable growths.

### EXAMPLE 2

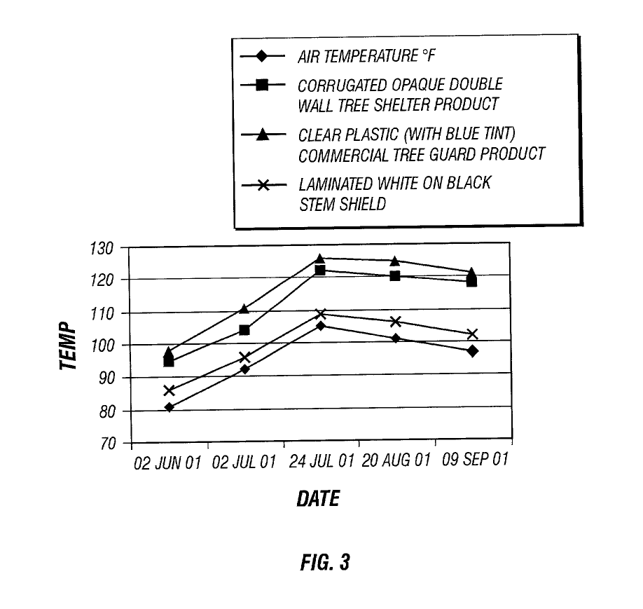

Trees were arranged in the same groups as in Example 1. Temperatures were monitored a number of times during the growing season. Temperatures inside the laminated material, white on the outside, were consistently 4 to 6 degrees above the ambient air temperature, but the temperatures inside other types of plant shields were much higher. These temperatures are depicted graphically in FIG. 3. Further, as the sun shifted southward in the summer sky and the sunlight contact became more direct, the heating inside the laminated shield of the present invention increased, but not to as high of a temperature as with other shields.

The term “comprising” means that the recited elements or steps may be only part of the apparatus or method and does not exclude additional unrecited elements or steps.

It will be understood that certain combinations and sub-combinations of the invention are of utility and may be employed without reference to other features in sub-combinations. This is contemplated by and is within the scope of the present invention. As many possible embodiments may be made of this invention without departing from the spirit and scope thereof, it is to be understood that all matters hereinabove set forth or shown in the accompanying drawings are to be interpreted as illustrative and not in a limiting sense.

I claim:

1. A shield for protecting a plant stem, comprising:
a flexible composite sheet having an inner layer of non-abrasive material secured to a outer layer of a herbicide-impermeable material, wherein the flexible composite sheet has two ends coupled together to form a circumferential barrier.

2. The shield of claim 1, wherein the circumferential barrier encircles the plant stem.

3. The shield of claim 1, wherein the flexible composite sheet has a plurality of layers.

4. The shield of claim 1, wherein the flexible composite sheet is sufficiently stiff that the shield is self-supporting.

5. The shield of claim 1, wherein the second layer is water or chemical impermeable.

6. The shield of claim 1, wherein the herbicide-impermeable material is also water impermeable.

7. The shield of claim 1, wherein the herbicide-impermeable material is also chemical-impermeable.

8. The shield of claim 1, wherein the two ends of the flexible composite sheet are coupled together by a fastener selected from a staple, adhesive, snap, clasp, hook and loop fastener, and combinations thereof.

9. The shield of claim 1, wherein the non-abrasive material is a porous fabric.

10. The shield of claim 9, wherein the porous fabric has a weight between 2 and 10 ounces per square yard.

11. The shield of claim 9, wherein the porous fabric has a weight between 4 and 6 ounces per square yard.

12. The shield of claim 9, wherein the porous fabric is selected from a spun bonded, needle punched fabric, a woven fabric, a knitted fabric, and combinations thereof.

13. The shield of claim 9, wherein the porous fabric is selected from polyester, polypropylene, cotton, and combinations thereof.

14. The shield of claim 9, wherein the porous fabric is opaque.

15. The shield of claim 9, wherein the porous fabric is black or gray.

16. The shield of claim 1, wherein the non-abrasive material is bonded onto the herbicide-impermeable material by a method selected from gluing, laminating, and combinations thereof.

17. The shield of claim 1, wherein the herbicide-impermeable material is reflective.

18. The shield of claim 1, wherein the herbicide-impermeable material is selected from a metal sheet, a metal foil, a polymer sheet, and combinations thereof.

19. The shield of claim 1, wherein the herbicide-impermeable material is a polymer sheet.

20. The shield of claim 19, wherein the polymer sheet is selected from polyethylene and polypropylene.

21. The shield of claim 1, wherein the herbicide-impermeable material is white and the non-abrasive material is black or gray.

22. The shield of claim 1, wherein the herbicide-impermeable material has a thickness between 2 and 10 mils.

23. The shield of claim 1, wherein the herbicide-impermeable material has a thickness between 3 and 5 mils.

24. The shield of claim 9, wherein the herbicide-impermeable material is polyethylene containing ultraviolet inhibitors.

25. The shield of claim 1, wherein the non-abrasive material is resilient.

26. A shield for protecting a plant stem, consisting essentially of:
a flexible composite sheet having an inner layer of non-abrasive material secured to a outer layer of a herbicide-impermeable material, wherein the flexible composite sheet has two ends coupled together to form a circumferential barrier.

27. The shield of claim 26, wherein the circumferential barrier encircles the plant stem.

28. The shield of claim 26, wherein the herbicide-impermeable material is a polyethylene sheet.

29. A shield for protecting a plant stem, comprising:
a circumferential barrier including a polymer sheet having an inner surface and a porous fabric secured to the inner surface of the polymer sheet.

30. The shield of claim 29, wherein the porous fabric layer is selected from spun bonded and needle punched fabric, woven fabric, knitted fabric, and combinations thereof.

31. The shield of claim 29, wherein the porous fabric layer has a weight between 2 and 10 ounces per square yard.

32. The shield of claim 29, wherein the porous fabric layer has a weight between 4 and 6 ounces per square yard.

33. The shield of claim 29, wherein the porous fabric is selected from polyester, polypropylene, cotton, and combinations thereof.

34. The shield of claim 29, wherein the polymer sheet is white and the porous fabric is black.

35. The shield of claim 29, wherein the porous fabric is bonded onto the polymer sheet by a method selected from gluing, laminating and combinations thereof.

36. The shield of claim 29, wherein the polymer sheet is white and the porous fabric layer is black.

37. The shield of claim 29, wherein the porous fabric layer is bonded onto the polyethylene sheet by a method selected from gluing, laminating and combinations thereof.

38. The shield of claim 29, wherein the polymer sheet is a polyethylene sheet having a thickness between 2 and 10 mils.

39. The shield of claim 38, wherein the polyethylene sheet is white and the porous fabric layer is black.

40. An apparatus for protecting a plant stem, comprising:
a flexible composite sheet having an inner layer of non-abrasive material secured to a outer layer of a herbicide-impermeable material, wherein the flexible composite sheet has two ends adapted to be coupled together to form a circumferential barrier around a plant stem.

41. The apparatus of claim 40, wherein the two ends of the flexible composite sheet are adapted to be coupled by a fastener selected from a staple, adhesive, snap, clasp, hook and loop fastener, and combinations thereof.
